(19) United States
(12) Patent Application Publication
(10) Pub. No.: US 2009/0127185 A1
(43) Pub. Date: May 21, 2009

(54) FILTER ELEMENT

(75) Inventors: Wolfgang Stausberg, Morsbach (DE); Daniel Bernards, Lindlar (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: IBS Filtran Kunststoff-/Metallerzeugnisse GmbH, Morsbach (DE)

(21) Appl. No.: 12/275,538

(22) Filed: Nov. 21, 2008

(30) Foreign Application Priority Data
Nov. 21, 2007 (EP) 07022589.1

(51) Int. Cl. B01D 29/58; B01D 35/30

(52) U.S. Cl. 210/454; 210/497.1

(57) ABSTRACT

The invention relates to a filter element for filtering fluid for a motor or gearing, comprising a first filter medium which is arranged in a cylindrical way, with the fluid impinging in a perpendicular way on the circumferential surface of the first medium for filtering in an associated filter apparatus, then penetrating and passing through the same. The filter element comprises a second filter medium with a filter density differing from the first filter medium, the first filter medium and the second filter medium being stacked upon each other as filter layers and being jointly wound in a spiral manner. A desired purity of the fluid can thus be achieved more quickly than in filter elements which exclusively allow a radial passage of the fluid through the filter elements. The spiral configuration also achieves a higher dirt absorption capacity.

### PRIORITY

This application claims priority to EP 07022589.1 filed Nov. 21, 2007, the entire contents of which is incorporated by reference herein.

### BACKGROUND OF THE INVENTION

### Field of the Invention

The invention relates to a filter element for filtering fluid for a motor or a gearing, with the filter element having a first filter medium which is arranged in a cylindrical way. The invention further relates to a filter apparatus with such a filter element.

Pressure filters can be used in fluid bypass for filtering of fluid in a motor or a gearing. In order to avoid endangering the cooling output of the motor or gearing, it is relevant that a sufficient volume flow is always allowed to pass through the pressure filter or the associated filter element. In the case of even volume flow, a rise in the differential pressure between fluid inlet and fluid outlet of the filter element can occur whose its fluid permeability has decreased as a result of the absorbed filter particles. Once the differential pressure exceeds a predetermined value, the fluid can usually be guided through a bypass valve without passing through the filter element and there being filtering.

A cylindrical filter element can be used as a filter element in a pressure filter which is arranged as a felt shell element, felt stuffing-box packing or a wound filter in form of a “massive” filter element. The packing density of filter fibers is very high in such a filter element, thus leading to a high flow resistance. Relatively low particle loadings will quickly lead to a very high rise in differential pressure. The fluid flow occurs radially from the outside to the inside. The surface approached by the flow is relatively small.

As an alternative to this, the cylindrical filter element can also be arranged in a star-folded manner in pleated form. It is not intended to achieve a high fiber density with high filtration performance, but the highest possible filtration surface area. The differential pressure remains relatively low in such a filter element with a low media thickness. Such a filter element does not accumulate filter particles that need to be removed so quickly and achieves a higher service life than the massive filter element. The star-folded filter element is complicated to produce. The star folding is performed by means of a pleating system, with such a process being time-consuming and expensive. Moreover, as a result of the prevailing differential pressure it is necessary to provide the filter medium with a support grating in order to prevent the collapse of the star folds, which thus further increases the costs for this filter element. There must also be a sealing of the fold stars on the face side, so that no circumvention of the filter element will occur (which is usually: gluing, welding between filter medium and end cap).

### SUMMARY OF THE INVENTION

It is an object of the invention to provide a filter element for filtering fluid for a motor or gearing, with the filter element having a filter medium which is arranged cylindrically, with a low rise in differential pressure, a high filter service life and a high filtration performance being achieved even in the case of a wide distribution of particle sizes, and with the filter element being easy to produce at low cost. Furthermore, the filter element should have a high capacity to absorb dirt and enable a high particle cleansing speed. No support grating should be required and simple sealing of the face sides of the filter element should also be possible. It is further the object of the invention to provide a filter apparatus with such a filter element.

This object is achieved by the subject matters of the independent claims. Advantageous further developments of the invention are the subject matter of the sub-claims.

The filter element in accordance with the invention for filtering fluid for a motor or a gearing comprises a first filter medium which is arranged in a cylindrical way, with the fluid impinging in a perpendicular way the circumferential surface of the first filter medium for filtering in an associated filter apparatus, penetrating and passing through the same. The filter element has a second filter medium with a filter density which differs from the first filter medium, with the first filter medium and the second filter medium being stacked upon one another as filter layers and them being wound together in a spiral way. As a result of the different filter density of the filter media, impinging fluid will not simply enter the filter media in a radial manner, but will be guided within a filter medium and along the phase boundary formed by the mutually stacked filter media. This leads to a spiral flow channel or a flow layer for the fluid to be filtered, as a result of which the fluid can penetrate the filter element more deeply than when it would impinge only frontally on a single filter medium. One of the two filter media thus acts like a drainage layer. The fluid can also pass through the second filter medium and need not flow along a spiral path from the outer beginning to the inner end of a filter medium, so that the fluid can seek the optimal passage itself depending on its purity.

A further advantage of this filter element in accordance with the invention is that as a result of the spiral flow layer and the possibility to penetrate the filter element more deeply, a more homogeneous loading of the filter medium, a lower rise in the differential pressure and a higher service life of the filter is achieved. There is a more rapid filtering because a larger filter media surface and a larger filter media volume respectively is used. As a result, the particles to be filtered not only get caught in the outermost filter media position, which thus rapidly reach its maximum particular absorption capacity, but the particles can also use a larger filter media volume for separation, so that the particle absorption capacity of the entire filter element is increased. Furthermore, the filtration performance increases by the use of two differently dense filter media. A support grating or the like is not required, because as a result of the spiral structure sufficient stability is produced. As a result of the spiral arrangement of the filter element, there is also a much simpler arrangement than in the case of the star-shaped pleated filter element, so that the production is more cost-effective and the face sides can be sealed in a relatively simple way.

It is advantageous when one of the filter media is a coarse filter medium and the other filter medium is a fine filter medium. Depending on the quality of the fluid and depending on the application, it is also possible to use a fine filter medium and an ultra-fine filter medium. It is merely relevant however that the filter density of the two filter media is different, so that a relatively viscous fluid is absorbed by the coarser filter medium and guided further in a spiral manner.

Especially preferably, the fluid first meets the coarse filter medium and then the fine filter medium when seen in the direction of the fluid flow, so that the coarse filter medium forms an outside layer and the fine filter medium an inside layer. A cascaded filtering is thus achieved already at the beginning of the filtering.

According to a further embodiment, at least one additional filter medium is arranged as an additional filter layer on the first and second filter medium. It is thus possible to achieve an even finer grading of the filtering without changing the above described effective principle of the filter element in accordance with the invention.

It is advantageous when one end of the outside layer protrudes over the adjacent end of the inside layer. As a result, the grading of the filter media coating at the end and beginning of the spiral is lower than if there were no excess portion. The filter element thus achieves an approximately circular cross section and can be installed in a relatively simple way in a filter apparatus. Furthermore, the flow of a fluid flowing about the outside layer of the filter element has a lower flow obstruction, which thus allows a relatively calmed penetration of the fluid into the filter element.

The protruding end of the outside layer can further be used in order to fasten the same to an outside layer of a subsequent winding plane. This prevents the spiral from being wound up, with such a fastening at the end of the outside layer enabling a failure-free, simple and cost-effective production of the filter element. Preferably, the fastening can be made by means of welding, preferably ultra-sonic welding.

The coarse filter medium is preferably a polyester needle-punched non-woven and the fine filter medium preferably comprises glass fibers. In comparison with filter paper for example, deep filtration media are used which have a higher filtration performance. The filter media are not wavy or V-shaped and are not glued to each other at the circumference, as is usually the case with filter media that are flowed through axially, but adhere to one another by their own circumferential tensioning.

In one embodiment of the invention, the filter media of the filter element are pressed against each other on at least one face side in a fluid-tight manner. Cumbersome gluing is thus not required.

The object is further achieved by a filter apparatus with a filter element as described above, with the filter apparatus comprising a filter end cap on at least one face side in order to prevent any fluid outlet at the sides. A bypass valve can also be attached to said end cap which offers a yielding possibility for the fluid in the case of excessive differential pressure on the filter element.

The invention is now explained in closer detail by reference to embodiments shown in the drawings, wherein:

### BRIEF DESCRIPTION OF THE DRAWINGS

FIG. 1 shows a schematic top view of a first embodiment of the filter element in accordance with the invention;

FIG. 2 shows a schematic view of a first embodiment of the filter apparatus in accordance with the invention in a cross-sectional view, and

FIG. 3 shows a diagram in which the particle count is shown depending on the filtration duration for different particle sizes, by using the first embodiment of the filter element in accordance with the invention.

### DETAILED DESCRIPTION OF THE DRAWINGS

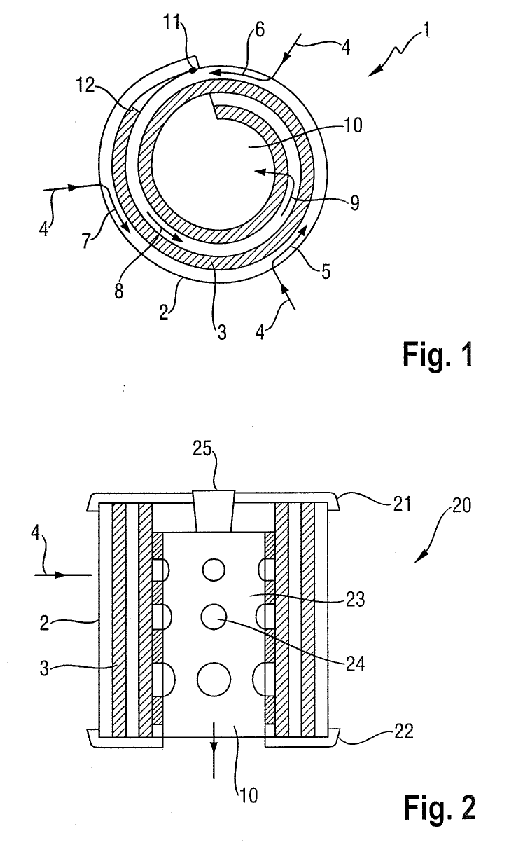

FIG. 1 shows a filter element 1 which is composed of a coarse filter medium 2 as the outside layer and a fine filter medium 3 as the inside layer. The two layers are stacked on each other and are wound up together in a spiral way. A space can be provided between the two filter media, with the two layers touching each other in the embodiment as shown in FIG. 1, so that a compact structure is achieved. The fluid to be filtered meets the circumferential surface of the outside layer in a perpendicular way (see arrow 4) and penetrates said outside layer. Filtering starts there, with the fluid meeting the fine filter medium 3 after penetrating the coarse filter medium 2. A portion of the fluid will penetrate the fine filter medium 3, with another portion proceeding along the coarse filter medium 2 in a spiral way in the direction of the geometric center of the filter element 1 (see arrows 5 to 8). After passing a certain path length in the coarse filter medium 2, the fluid can also pass through the fine filter medium (see arrow 9) and leave the filter element in the center 10.

FIG. 1 shows the supply of the fluid with arrows 4. It is only shown for reasons of clarity. A fluid used in a filter apparatus can obviously penetrate the coarse filter medium 2 along the entire circumference.

Loading of the coarse filter medium occurs not only in the outermost winding layer, but also in the inner winding layers because the fluid can be discharged in a spiral manner like in a drainage. This leads to a higher particle absorption capacity than in conventional filters which only allow a radial transport of fluid through the filter media.

The fastening of the coarse filter medium 2 can occur at one end 11 on the outside layer in such a way that it is welded with ultrasonic sound for example with the coarse filter medium in the winding plane below. Since the filter media concern the same type (coarse filter medium), both welding zones have the same melting point, so that reliable welding can be achieved. The inside layer is shortened in this area (see 12), so that the end of the outermost outside layer protrudes beyond the end of the outermost inside layer.

FIG. 2 shows a cross-sectional view through a filter apparatus 20 with the filter element 1, with a cap 21 and 22 being attached to the respective face sides. These caps prevent the leakage of fluid, so that the fluid is forced to pass through the filter media. The filter apparatus can further be provided with a core 23 for better stabilization of the filter element and/or for better receiving the caps 21 and 22, which core comprises the openings 24 for the penetrating fluid. In the embodiment as shown in FIG. 2, the upper cap 21 additionally comprises a bypass valve 25, so that in the case of excessive differential pressure the fluid can circumvent the filter media and can directly reach the fluid outlet in the center 10 of the filter element.

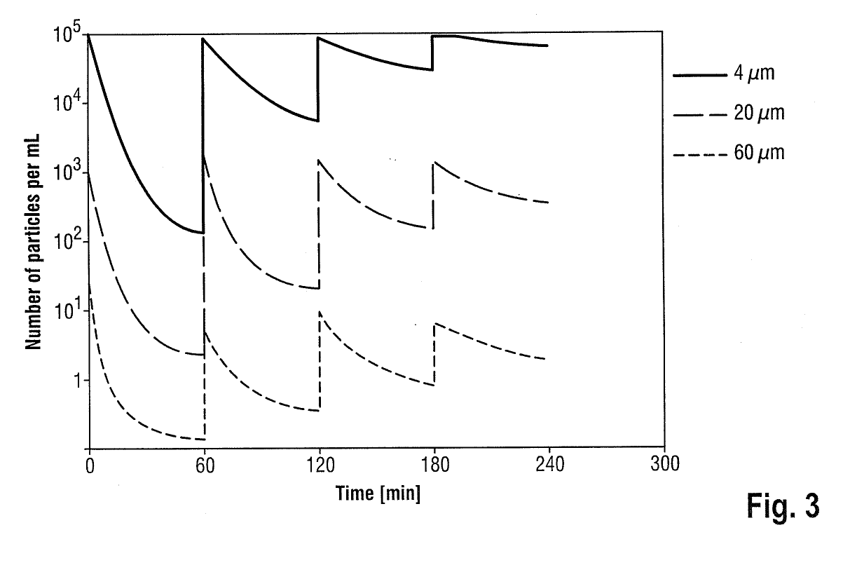

The effect of the filter element in accordance with the invention is shown in a diagram in FIG. 3. The ordinate shows the number of particles per milliliter in the filtered fluid on a logarithmic scale and the abscissa shows the duration of a test. The curves represent the number of particles depending on time, with the results applying for particles of size 4 microns, 20 microns and 60 microns. At the beginning, i.e. at the time “0 minutes”, 2 grams of a standardized particle quantity (ISO MTD) are added to the fluid. The fluid was continually cleaned from the filter element, so that with increasing duration of the test the curves for all particle sizes show a degressive curve. This means a decreasing number of particles with progressive filtering. After 60 minutes, 2 grams of the standardized quantity of particles were added to the fluid, so that immediately the number of measured particles in the fluid increased. With progressive duration of the test, the number of particles decreased however. After 120 minutes the values no longer reached the low level which was present after 60 minutes. This can be interpreted as an indication that the filter element was occluded more and more with particles. The process with the addition of two grams of a standardized quantity of particles was repeated after 120 minutes, with the curves again showing a degressive curve after a rapid rise. Although after 180 minutes the number of particles was lower than after the beginning of the second addition of particles, the values were above those however which were reached after 120 minutes.

For comparison purposes, this test was performed with a filter element which allowed only one radial through-flow with a single filter medium. The progress of the curve was principally comparable, but the number of particles after 60, 120 and 180 minutes were each considerably higher than in a filtering with the filter element in accordance with the invention. The particle absorption capacity is approximately 33% higher in the filter element in accordance with the invention than in a filter element with exclusively radial passage of fluid. A required purity of the fluid and number of particles in the fluid was thus reached with the filter element in accordance with the invention more rapidly.

What is claimed is:

1. A filter element for filtering fluid for a motor or gearing, comprising a first filter medium which is arranged in a cylindrical way, with the fluid impinging in a perpendicular way on the circumferential surface of the first medium for filtering in an associated filter apparatus, then penetrating and passing through the same, wherein the filter element comprises a second filter medium with a filter density differing from the first filter medium, the first filter medium and the second filter medium being stacked upon each other as filter layers and being jointly wound in a spiral manner.

2. A filter element according to claim 1, wherein one of the filter media is a coarse filter medium and the other filter medium is a fine filter medium.

3. A filter element according to claim 2, wherein, when seen in the direction of the fluid flow, the fluid first meets the coarse filter medium and thereupon the fine filter medium, so that the coarse filter medium forms an outside layer and the fine filter medium an inside layer.

4. A filter element according to claim 1, wherein at least one additional filter medium is arranged as an additional filter layer on the first and second filter medium.

5. A filter element according to claim 3, wherein one end of the outside layer protrudes beyond the adjacent end of the inside layer.

6. A filter element according to claim 5, wherein the protruding end of the outside layer is fastened to an outside layer of a subsequent winding plane.

7. A filter element according to claim 6, wherein the fastening can be performed by means of welding, preferably ultrasonic welding.

8. A filter element according to claim 1, wherein the coarse filter medium comprises a polyester needle-punched non-woven and the fine filter medium comprises glass fibers.

9. A filter element according to claim 1, wherein the filter media of the filter element are pressed together in a fluid-tight manner on at least one face side.

10. A filter apparatus with a filter element according to claim 1, wherein the filter element comprises a filter end cap on at least one face side.

11. A filter apparatus according to claim 9, wherein the filter end cap comprises a bypass valve.
